(19) United States
(12) Patent Application Publication
(10) Pub. No.: US 2023/0172261 A1
(43) Pub. Date: Jun. 8, 2023

(54) AEROSOL-GENERATING ROD SEGMENT AND AEROSOL-GENERATING ARTICLE COMPRISING SUCH A SEGMENT

(71) Applicant: Philip Morris Products S.A., Neuchatel (CH)

(72) Inventors: Frederic Ulysse BUEHLER, Neuchatel (CH); Jerome Christian COURBAT, Cortaillod (CH); Onur DAYIOGLU, Neuchate (CH); Oleg MIRONOV, Cudrefin (CH); Enrico STURA, Palézieux-Village (CH); Denis NIZOVTSEV, Le Locle (CH); Carlo ZANIBONI, Castenaso (IT)

(73) Assignee: Philip Morris Products S.A., Neuchatel (CH)

(21) Appl. No.: 17/997,673

(22) PCT Filed: May 3, 2021
(86) PCT No.: PCT/EP2021/061584

§ 371 Date: Nov. 1, 2022

(30) Foreign Application Priority Data
May 5, 2020 (EP) 20172866.4

(51) Int. Cl. A24D 1/20; A24D 1/04; H05B 6/10

(52) U.S. Cl. CPC A24D 1/20; A24D 1/045; H05B 6/108; A24F 40/20

(57) ABSTRACT

An aerosol-generating rod segment is provided, including: a rod-shaped susceptor casing; and an aerosol-forming gel contained in the rod-shaped susceptor casing, in which the rod-shaped susceptor casing includes a bottom, a side wall, and an opening arranged opposite the bottom, in which the aerosol-forming gel is retained inside the rod-shaped susceptor casing in axial direction of the aerosol-generating rod segment by at least one positive locking means, in which the side wall of the rod-shaped susceptor casing is corrugated, in which at least one of the at least one positive locking means is an inwardly directed seam of the rod-shaped susceptor casing arranged adjacent to an end section of the rod-shaped susceptor casing, the end section being arranged opposite the bottom of the rod-shaped susceptor casing, and in which the inwardly directed seam is formed by an inwardly bent end portion of the side wall of the rod-shaped susceptor casing.

The present disclosure relates to aerosol-generating segments used in aerosol-generating articles. In particular, the disclosure relates to an inductively heatable aerosol-generating segment comprising aerosol-forming gel.

Aerosol-generating articles comprising several segments arranged in an end-to-end position are known. One of the segments may be a segment comprising an aerosol-forming substrate and a susceptor for heating the aerosol-forming substrate.

It is desirable to provide an aerosol-generating rod segment to be used in an aerosol-generating article that is inductively heatable and wherein the rod segment comprises an aerosol-forming substrate in the form of a gel.

According to the invention there is provided an aerosol-generating rod segment comprising a rod-shaped susceptor casing and an aerosol-forming gel contained in the rod-shaped susceptor casing. The susceptor casing comprises a bottom, a side wall and an opening arranged opposite the bottom. The aerosol-forming gel is retained inside the susceptor casing in axial direction of the aerosol-generating rod segment by at least one positive locking means.

Aerosol-forming substrate in the form of gel has the advantage that a substrate may be provided basically having any shape. However, as gel as such is air-tight, any vaporized gel may cause pressure on the remaining gel that is not or not yet vaporized. If, for example, a gel plug is heated at one end of the plug, the entire plug may be forced out of its position. However, the provision of aerosol-forming substrate in the form of gel in a casing has several advantages. The gel may be filled into the casing, for example in a liquid form and may thus come in intimate contact with the casing. By this, heat transfer from the casing to the aerosol-forming gel is very direct and optimized. Casings additionally made of a susceptor material may directly be heated via induction heating in a power saving manner and such that no extra material or space is needed for electrical wires or resistive heaters.

A casing is generally as open as possible in order to use as little material as possible, in particular since aerosol-generating articles comprising rod-shaped aerosol-generating segments are articles that are typically disposed of after use. Yet further, a casing needs to be open for filling the casing or at least for vaporized gel to leave the casing. Positive locking means provided in or at the casing acting in axial direction on the aerosol-forming gel allow to retain the aerosol-forming gel in the casing. For example, when a casing is heated at the bottom of the casing gel is vaporized at the bottom end of the casing. The generated vapour now tends to push the remaining non-vaporized gel in axial direction out of the casing through the opening of the casing arranged opposite the bottom. Positive locking means provided in the casing may hold this non-vaporized gel in the casing.

The positive locking means may be arranged at various positions on or in the casing and may also be designed in various shapes in order to fulfil the retaining action in axial direction of the aerosol-generating rod segment.

Preferably, at least one of said at least one positive locking means is designed as an inwardly directed seam of the susceptor casing. In particular, the at least one positive locking means may form an inwardly arranged flange of the casing. The seam may be arranged adjacent to an end section of the susceptor casing, which end section is arranged opposite the bottom of the susceptor casing.

Preferably, a positive locking means in the form of a seam is formed by an inwardly bent end portion of the side wall of the susceptor casing. Inwardly bent end portions of the side wall are advantageous from a manufacturing point of view as no extra seam or flange needs to be attached to the casing. In addition, no unintentional leak may be present between a casing and a separately attached seam. Yet further, the casing may, for example, be formed, filled with gel and then partly closed by simply bending end portions of the casing walls radially inwardly.

Preferably, at least one of said at least one positive locking means is designed as a radially inwardly directing protrusion. The radially inwardly directing protrusion has a radial extension in circumferential direction of the susceptor casing, which radial extension is larger than a longitudinal extension of the protrusion in longitudinal direction of the susceptor casing. The radially inwardly directing protrusion preferably forms one or several ribs arranged circumferentially along the interior of the sidewall of the casing.

The radially inwardly directing protrusion may be formed, for example, by a thicker side wall at the position of the protrusion. The radially inwardly directing protrusion may be formed, for example, by a locally deformed casing.

Preferably, the radially inwardly directing protrusion is a radially inwardly directing deformation of the side wall of the susceptor casing. Deformations of the side wall may be present in the casing before filling the casing or may be created after the casing has been filled, for example together with an inwardly directing seam at the opening end of the casing.

The protrusion may be arranged at any position along the length of the casing. Preferably, the protrusion is arranged between half of the height of the casing and the opening of the casing. Preferably, the radially inwardly directing protrusion is arranged in an intermediate section of the side wall of the susceptor casing.

An intermediate section may basically extend between the two extreme ends of the casing, thus between the bottom and the opening end of the casing. The intermediate section preferably extends over about 20 percent and about 95 percent of the length of the casing, more preferably between about 30 percent and about 90 percent, for example between about 40 percent and about 60 percent of the length of the casing.

The positive locking means preferably comprise several protrusions. The several protrusions may, for example, be arranged at a distance to each other along the length of the casing. The several protrusions may, for example, be arranged at different circumferential positions. In addition or alternatively, the several protrusions may, for example, be arranged opposite each other at a same longitudinal length position of the casing.

The at least one positive locking means may be provided in one, two, three, four or in a plurality of sectors of the susceptor casing. The at least one positive locking means may, for example, be a continuous protrusion such as a continuous rib arranged along the circumference of the susceptor casing. The at least one positive locking means may, for example, be a discontinuous protrusion such as a discontinuous rib arranged along the circumference of the susceptor casing.

The at least one positive locking means is preferably provided in a circumferential range of each sector of at least 5 degree, 10 degree, 15 degree, 20 degree , 30 degree , 40 degree , 45 degree or up to 20 degree, 30 degree, 40 degree, 45 degree, 50 degree, 60 degree, 70 degree, 80 degree, 90 degree or 180 degree.

Preferably, at least one of the at least one positive locking means is arranged along an entire circumference of the susceptor casing, in particular along an entire circumference of the side wall of the susceptor casing.

The at least one positive locking means may be provided along an entire length of the casing, for example sequentially or continuously. For example, the at least one positive locking means may be formed by parts of the side walls or by entire side walls that are continuously converging radially inward from a bottom of the casing to the opening of the casing. The casing may, for example, form a truncated hollow cone. The casing may, for example, have a folded side wall structure, where some of the folds or corrugations continuously converge radially inward. The converging side walls form a positive locking means constructed to act along the entire length of the casing as a retention for the aerosol-forming gel in longitudinal direction of the casing. Preferably, corrugations converge radially inwardly toward the opening of the susceptor casing. Preferably, some corrugations, for example a third, half or all corrugations, converge radially inwardly toward the opening of the susceptor casing.

The aerosol-forming gel may be retained in the cartridge by the at least one positive locking means with clearance in the longitudinal direction of the susceptor casing. Clearance may, for example, be present when the casing is not entirely filled with aerosol-forming gel. A clearance then extends between a filling level of the gel and the positive locking means. A filling level may, for example, be at about half or three-quarter of the length of the casing, while the positive locking means may be provided, for example, at or near the opening end of the casing.

The aerosol-forming gel may be fixed in its position in the susceptor casing by the at least one positive locking means. Thus, the aerosol-forming gel may be fixed in its position without clearance. For example, a casing may entirely be filled with aerosol-forming gel. Alternatively, the aerosol-forming gel may be fixed in its position by the positive locking means arranged along the length of the casing. Thus, the positive locking means may be provided in an intermediate section of the casing between the bottom of the casing and a filling level of the gel. For example, the gel may be filled to a filling level corresponding to about three-quarter of the casing, while the positive locking means may be arranged between the bottom of the casing and three-quarter of the casing, preferably at about half of the length of the casing.

The side wall of the susceptor casing may be made of susceptor material. The bottom of the susceptor casing may be made of susceptor material. Preferably, at least part of the bottom and part of the side wall of the casing are made of susceptor material. More preferably, the entire bottom and the entire side wall of the casing are made of susceptor material.

The bottom of the susceptor casing may be open or may be closed. For example, the bottom may comprise one or several openings, for example, for an airflow to pass through the bottom opening into the casing.

Preferably, the bottom of the susceptor casing is closed.

The side wall of the susceptor casing may be even. The side wall of the susceptor casing may be corrugated. Preferably, corrugations are aligned in a longitudinal direction of the susceptor casing. Corrugations enlarge the overall size of the surface of the susceptor and by this a contact surface between the aerosol-forming gel and the susceptor material.

Preferably, the side wall of the susceptor casing has the form of a cylinder. The cylinder may have a circular or non-circular cross section.

The bottom and the side wall of the susceptor casing may comprise a same thickness or a same material. The bottom and the side wall of the susceptor casing may comprise a same thickness and a same material. Preferably, the bottom and side wall of the susceptor casing are made of a same susceptor material.

Preferably, the bottom of the susceptor casing and the side wall of the susceptor casing are made as a single piece. For example, bottom and side wall are folded from the same sheet of susceptor material.

The bottom may have a circular cross-section or may, for example, be a polygon.

The bottom and the side wall of the susceptor casing may comprise a different thickness or a different material. The bottom and the side wall of the susceptor casing may comprise a different thickness and a different material.

The susceptor casing or parts of the casing may be made of any susceptor material suitable for forming a rod-shaped casing containing aerosol-forming gel, wherein the casing containing the gel is part of or forms an aerosol-generating rod segment. Preferably, the susceptor casing comprises or is made of aluminium or stainless steel.

Preferably, the susceptor casing is formed from a sheet of susceptor material having a thickness between 5 micrometer and 80 micrometer, preferably between 8 micrometer and 50 micrometer.

Preferably, the aerosol-forming gel is a gel plug. The gel plug may be formed before being inserted into the casing. The gel plug may be formed in the casing, for example, by filling liquid aerosol-forming gel into the casing and subsequently solidifying the gel. The gel plug may be inserted into the casing before forming the at least one positive locking means.

The aerosol-forming gel may have a filling height of at least 30 percent, 40 percent, 50 percent, 60 percent, 70 percent, 80 percent or at most 30 percent, 40 percent, 50 percent, 60 percent, 70 percent, 80 percent, 90 percent, 95 percent, 96 percent, 97 percent, 98 percent, 99 percent of the susceptor casing.

Preferably, the aerosol-forming gel is entirely contained inside the susceptor casing.

Preferably, the aerosol-forming gel comprises a solidifiable material.

Preferably, the aerosol-forming gel comprises a thermoreversible material.

The aerosol-forming gel may comprise a gelling agent. Preferably, the aerosol-forming gel comprises between 0.5 percent and 5 percent by weight of a gelling agent, for example between 0.7 percent and 2 percent by weight or between 0.8 percent and 1 percent by weight of a gelling agent.

The aerosol-generating rod segment may be substantially cylindrical in shape. The aerosol-forming rod segment is substantially elongate. The aerosol-forming rod segment also has a length and a circumference substantially perpendicular to the length.

The aerosol-generating rod segment has a diameter that is approximately equal to a diameter of the aerosol-generating article. Preferably, the aerosol-generating rod segment has a diameter between 5 millimeter and 10 millimeter. It is preferable that the diameter of the aerosol-generating rod segment is greater than 5 mm, for example between 6 mm and 8 mm. The aerosol-generating rod segment has a length that may be defined as the dimension along the longitudinal axis of the aerosol-generating article. The length of the aerosol-generating rod segment may be between 5 millimeter and 20 millimeter, for example between 6 mm and 16 mm or between 7 mm and 12 mm, for example 7 millimeter. It is preferred that the aerosol-generating rod segment is substantially cylindrical.

The invention also refers to an aerosol-generating article, in particular an inductively heatable aerosol-generating article, comprising a plurality of segments arranged in an end-to-end position and wrapped in a wrapper to form a rod. The plurality of segments comprises an aerosol-generating rod segment as described in the present application.

The plurality of segments may comprise one or more hollow tubes, a spacer element, an airflow directing element, an empty cavity, a second susceptor containing element, an aerosol-cooling element and a filter segment.

Preferably, the plurality of segments comprises at least one of a hollow tube, a filter segment, an airflow directing element and an empty cavity.

The aerosol-generating article may comprise a mouthpiece element. The mouthpiece element may be located at the mouth end or downstream end of the aerosol-generating article.

The mouthpiece element may comprise at least one filter segment. The filter segment may be a cellulose acetate filter plug made of cellulose acetate tow. The filter segment is 6 millimeter in length in one embodiment, but may have a length of between 4 millimeter and 14 millimeter.

The aerosol-generating article may comprise a support element that may be located immediately downstream of the aerosol-generating rod segment and may abut the aerosol-generating rod segment.

The support element may be formed from any suitable material or combination of materials. For example, the support element may be formed from one or more materials selected from the group consisting of: cellulose acetate; cardboard; crimped paper, such as crimped heat resistant paper or crimped parchment paper; and polymeric materials, such as low density polyethylene (LDPE). In a preferred embodiment, the support element is formed from cellulose acetate.

The support element may comprise a hollow tubular element. In a preferred embodiment, the support element comprises a hollow cellulose acetate tube.

The support element preferably has an external diameter that is approximately equal to the external diameter of the aerosol-generating article.

The support element may have an external diameter of between 5 millimeter and 12 millimeter, for example of between 5 mm and 10 mm or of between 6 mm and 8 mm. In a preferred embodiment, the support element has an external diameter of 7.2 mm plus or minus 10 percent. The support element may have a length of between 5 millimeter and 15 millimeter. In a preferred embodiment, the support element has a length of 8 mm. The support element may have a wall thickness between 1.5 mm and 2 mm, preferably between 1.6 mm and 1.8 mm.

The aerosol-generating article may comprise a thin support element. The thin support element may have an external diameter of between 5 millimeter and 12 millimeter, for example of between 5 mm and 10 mm or of between 6 mm and 8 mm. In a preferred embodiment, the thin support element has an external diameter of 7.2 mm plus or minus 10 percent. The thin support element may have a length of between 5 millimeter and 15 millimeter. In a preferred embodiment, the thin support element has a length of 8 mm. The thin support element may have a wall thickness between 0.5 mm and 1 mm, preferably between 0.6 mm and 0.9 mm.

The aerosol-generating article may comprise an aerosol-cooling element. The aerosol-cooling element may be located downstream of the aerosol-generating rod segment, for example an aerosol-cooling element may be located immediately downstream of a support element, and may abut the support element.

The aerosol-cooling element may be located between the support element and a mouthpiece element located at the extreme downstream end of the aerosol-generating article.

As used herein, the term ‘aerosol-cooling element’ is used to describe an element having a large surface area and a low resistance to draw. In use, an aerosol formed by volatile compounds released from the aerosol-forming substrate is drawn through the aerosol-cooling element before being transported to the mouth end of the aerosol-generating article. In contrast to high resistance-to-draw filters, for example filters formed from bundles of fibers, aerosol-cooling elements have a low resistance to draw. Chambers and cavities within an aerosol-generating article such as expansion chambers and support elements are also not considered to be aerosol cooling elements.

An aerosol-cooling element preferably has a porosity in a longitudinal direction of greater than 50 percent. The airflow path through the aerosol-cooling element is preferably relatively uninhibited. An aerosol-cooling element may be a gathered sheet or a crimped and gathered sheet. An aerosol-cooling element may comprise a sheet material selected from the group consisting of polyethylene (PE), polypropylene (PP), polyvinylchloride (PVC), polyethylene terephthalate (PET), polylactic acid (PLA), cellulose acetate (CA), and aluminium foil or any combination thereof.

In a preferred embodiment, the aerosol-cooling element comprises a gathered sheet of biodegradable material. For example, a gathered sheet of non-porous paper or a gathered sheet of biodegradable polymeric material, such as polylactic acid or a grade of Mater-Bi<®> (a commercially available family of starch based copolyesters).

An aerosol-cooling element preferably comprises a sheet of PLA, more preferably a crimped, gathered sheet of PLA. An aerosol-cooling element may be formed from a sheet having a thickness of between 10 micrometer and 250 micrometer, for example 50 micrometer. An aerosol-cooling element may be formed from a gathered sheet having a width of between 150 millimeter and 250 millimeter. An aerosol-cooling element may have a specific surface area of between 300 millimeter² per millimeter length and 1000 millimeter² per millimeter length between 10 millimeter² per mg weight and 100 millimeter² per mg weight. In some embodiments, the aerosol-cooling element may be formed from a gathered sheet of material having a specific surface area of about 35 millimeter² per mg weight. An aerosol-cooling element may have an external diameter of between 5 millimeter and 10 millimeter, for example 7 mm.

In some preferred embodiments, the length of the aerosol-cooling element is between 10 millimeter and 15 millimeter. Preferably, the length of the aerosol-cooling element is between 10 millimeter and 14 millimeter, for example 13 millimeter.

In alternative embodiments, the length of the aerosol-cooling element is between 15 millimeter and 25 millimeter. Preferably, the length of the aerosol-cooling element is between 16 millimeter and 20 millimeter, for example 18 millimeter.

Preferably, the aerosol-generating rod segment is arranged between a hollow acetate tube and a filter segment.

The aerosol-generating article may be substantially cylindrical in shape. The aerosol-generating article may be substantially elongate. The aerosol-generating article may have a length and a circumference substantially perpendicular to the length.

The aerosol-generating article may have a total length between 30 millimeter and 100 millimeter. In preferred embodiments, the aerosol-generating article has a total length of between 40 mm and 55 mm, for example 42-52 mm.

The aerosol-generating article may have an external diameter between 5 millimeter and 12 millimeter, for example of between 6 mm and 8 mm. In a preferred embodiment, the aerosol-generating article has an external diameter of 7.2 mm plus or minus 10 percent.

The invention also refers to a method of manufacturing an aerosol-generating rod segment. The method comprises:

providing a rod-shaped susceptor casing comprising a bottom, a side wall and an opening opposite the bottom, filling aerosol-forming gel into the susceptor casing, providing at least one form locking means in the aerosol-generating rod segment, the at least one form locking means retaining the aerosol-forming gel inside the susceptor casing.

The at least one form locking means may be provided before or after the aerosol-forming gel has been filled into the susceptor casing. Preferably, the method comprises providing the at least one form locking means in the aerosol-generating rod segment after filling the susceptor casing with the aerosol-forming gel.

The form locking means may have different forms and positions as has been described with reference to the aerosol-generating rod segment. Preferably, the method comprises forming at least one form locking means by radially inwardly bending at least parts of the side wall of the susceptor casing. These parts may be end parts of the side wall or intermediate parts. Accordingly, the form locking means may be arranged at the opening of the casing or at one or several positions along the length of the casing.

Inwardly bending parts of the side walls are very simple means to manufacture positive form locking means for retaining the aerosol-forming gel in axial direction in the casing.

Depending on a filling method and consistency of the aerosol-forming gel, the forming of the positive locking may be chosen to be performed before or after filling the casing.

Preferably, the aerosol-forming gel is solidified after filling the aerosol-forming gel into the susceptor casing.

Preferably, the method comprises inwardly bending an end portion of the side wall, thereby defining a size of the opening of the susceptor casing. Such positive locking means are particularly advantageous as the locking means directly partially close the casing. Such positive locking means are advantageous as they are independent on a filling height of the gel in the casing. In addition, a size of the positive locking means may be varied by varying the length of the end portion that is bent inwardly.

The method may comprise providing corrugations in the side wall of the susceptor casing. By the provision of corrugations a surface of the susceptor casing and also a contact surface between susceptor and aerosol-forming gel may be enhanced by a same circumferential size of the casing and of the aerosol-generating rod segment.

Preferably, the corrugations extend from the bottom to the opening of the susceptor casing, thus along an entire length of the side wall of the susceptor casing.

The method may comprise forming at least one form locking means by forming radially inwardly directing protrusions in the side wall of the susceptor casing.

Preferably, the aerosol-generating rod segment manufactured according to the method according to the invention is an aerosol-generating rod segment according to the invention and as described herein.

As used herein, the term ‘susceptor’ refers to a material that can convert electromagnetic energy into heat. When located within a fluctuating electromagnetic field, typically eddy currents are induced and hysteresis losses occur in the susceptor causing heating of the susceptor. As the susceptor material is in direct physical and thermal contact with the aerosol-forming gel and the aerosol-forming gel is heated by the susceptor material.

The susceptor may be formed from any material that can be inductively heated to a temperature sufficient to generate an aerosol from the solid aerosol-forming substrate and the aerosol-forming liquid. Preferred susceptors comprise a metal or carbon. A preferred susceptor may comprise or consist of a ferromagnetic material, for example a ferromagnetic alloy, ferritic iron, or a ferromagnetic steel or stainless steel. A suitable susceptor may be, or comprise, aluminium. Preferred susceptors may be formed from 300 or 400 series stainless steels, for example grade 410, or grade 420, or grade 430 stainless steel. Different materials will dissipate different amounts of energy when positioned within electromagnetic fields having similar values of frequency and field strength. Thus, parameters of the susceptor such as material type, length, and thickness may all be altered to provide a desired power dissipation within a known electromagnetic field.

Preferred susceptors may be heated to a temperature in excess of 250° C.

The ‘aerosol-forming gel’ is herein understood to be a material or mixture of materials capable of releasing volatile compounds into an air stream passing through an article the susceptor is arranged in, preferably when the gel is heated. The provision of a gel may be advantageous for storage and transport, or during use, as the risk of leakage from the susceptor, aerosol generating article or aerosol generating device, may be reduced.

Advantageously the gel is solid at room temperature. ‘Solid’ in this context means that the gel has a stable size and shape and does not flow. Room temperature in this context means 25° C.

The gel may comprise an aerosol-former. Ideally the aerosol-former is substantially resistant to thermal degradation at the operating temperature of the susceptor. Suitable aerosol-formers are well known in the art and include, but are not limited to: polyhydric alcohols, such as triethylene glycol, 1, 3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Polyhydric alcohols or mixtures thereof, may be one or more of triethylene glycol, 1, 3-butanediol and, glycerine or polyethylene glycol.

Advantageously, the gel, for example, comprises a thermoreversible gel. This means that the gel will become fluid when heated to a melting temperature and will set into a gel again at a gelation temperature. The gelation temperature may be at or above room temperature and atmospheric pressure. Atmospheric pressure means a pressure of 1 atmosphere. The melting temperature may be higher than the gelation temperature. The melting temperature of the gel may be above 50° C., or 60° C. or 70° C. and may be above 80° C. The melting temperature in this context means the temperature at which the gel is no longer solid and begins to flow.

Alternatively, in specific embodiments, the gel is a non-melting gel that does not melt during use of the susceptor. In these embodiments, the gel may release the active agent at least partially at a temperature that is at or above the operation temperature of the susceptor in use, but below the melting temperature of the gel.

Preferably, the gel has a viscosity of 50,000 to 10 Pascal per second, preferably 10,000 to 1,000 Pascal per second to give the desired viscosity.

In combination with specific embodiments the gel comprises a gelling agent. In specific embodiments the gel comprises agar or agarose or sodium alginate or Gellan gum, or a mixture thereof.

In specific embodiments the gel comprises water, for example, the gel is a hydrogel. Alternatively, in specific embodiments the gel is non-aqueous.

Preferably the gel comprises an active agent. In combination with specific embodiments the active agent comprises nicotine (for example, in a powdered form or in a liquid form) or a tobacco product or another target compound for, for example, release in an aerosol. In specific embodiments the nicotine is included in the gel with an aerosol-former. Locking the nicotine into a gel at room temperature is desirable to prevent leakage of the nicotine from an aerosol-generating article.

In specific embodiments the gel comprises a solid tobacco material that releases flavour compounds when heated. Depending on the specific embodiments the solid tobacco material is, for example, one or more of: powder, granules, pellets, shreds, spaghettis, strips or sheets containing one or more of: plant material, such as herb leaf, tobacco leaf, fragments of tobacco ribs, reconstituted tobacco, homogenised tobacco, extruded tobacco and expanded tobacco.

There are embodiments where the gel comprises other flavours, for example menthol. Menthol can be added either in water or in the aerosol former prior to the formation of the gel.

In embodiments where agar is used as the gelling agent, the gel may comprise between 0.5 and 5 percent by weight, preferably between 0.8 and 1 percent by weight, agar. Preferably the gel further comprises between 0.1 and 2 percent by weight nicotine. Preferably, the gel further comprises between 30 percent and 90 percent by weight (or between 70 and 90 percent by weight) glycerine. In specific embodiments a remainder of the gel comprises water and flavourings.

Preferably the gelling agent is agar, which has the property of melting at temperatures above 85° C. and turning back to gel at around 40° C. This property makes it suitable for hot environments. The gel will not melt at 50° C., which is useful if the system is left in a hot automobile in the sun, for example. A phase transition to liquid at around 85° C. means that the gel only needs to be heated to a relatively low-temperature to induce aerosolization, allowing low energy consumption. It may be beneficial to use only agarose, which is one of the components of agar, instead of agar.

When Gellan gum is used as the gelling agent, typically the gel comprises between 0.5 and 5 percent by weight Gellan gum. Preferably the gel further comprises between 0.1 and 2 percent by weight nicotine. Preferably, the gel comprises between 30 percent and 99.4 percent by weight glycerin. In specific embodiments a remainder of the gel comprises water and flavourings.

In one example, the gel comprises 2 percent by weight nicotine, 70 percent by weight glycerol, 27 percent by weight water and 1 percent by weight agar.

In another example, the gel comprises 65 percent by weight glycerol, 20 percent by weight water, 14.3 percent by weight tobacco and 0.7 percent by weight agar.

There is also provided a method for assembling a rod-shaped aerosol-generating article comprising a cup-shaped susceptor. The cup-shaped susceptor may be a cup-shaped susceptor casing according to the invention and as described in the application.

The method comprises positioning a hollow tube in a vertical manner, providing a cup-shaped susceptor in the hollow tube, filling an aerosol-forming gel into the cup-shaped susceptor, and inserting an endpiece into the hollow tube.

A hollow tube may be positioned around a susceptor or a cup-shaped susceptor may be inserted into a hollow tube. Preferably, the cup-shaped susceptor is inserted in the hollow tube.

Preferably, the method comprises inserting the susceptor through a top end of the hollow tube and positioning the susceptor at a bottom end of the hollow tube. The cup-shaped susceptor may be arranged substantially flush with the bottom end of the hollow tube.

A cup-shaped susceptor may be filled with aerosol-forming gel before the susceptor is positioned in the hollow tube. The susceptor may be filled with gel after the susceptor has been positioned in the hollow tube. Preferably, the method comprises filling the cup-shaped susceptor with aerosol-forming gel after positioning the susceptor in the hollow tube.

The method may comprise inserting a gel dosing device in the hollow tube, dosing a desired amount of aerosol-forming gel into the susceptor and retreating the gel dosing device from the hollow tube. The gel may be in a liquid or paste form when being filled into the susceptor.

The endpiece may be inserted into the hollow tube through the top end of the hollow tube and close the hollow tube. The endpiece may be arranged flush with the top end of the hollow tube. The endpiece may form a recessed end of the hollow tube to form an aerosol-generating article with recessed filter end. The endpiece may extend from the hollow tube forming an extended filter portion of the article.

Preferably, a length of an aerosol-generating article is defined by the length of the hollow tube.

Preferably, the endpiece is a preassembled combination of segments. The endpiece may comprise, for example, one or more filter elements, one or more hollow tubes such as cellulose acetate tubes or a diffuser segment.

Preferably, the endpiece comprises at least one of a filter, a hollow tube and a diffuser element.

The hollow tube may be a cardboard tube or a plastics tube. Preferably, the hollow tube is a cardboard tube. Preferably, the hollow tube is a spirally-wound cardboard tube.

The hollow tube may have a diameter between 5 millimeter and 12 millimeter. Preferably, the diameter of the hollow tube is greater than 5 mm, for example between 6 mm and 8 mm.

The hollow tube may have a total length between 30 millimeter and 100 millimeter. In preferred embodiments, the hollow tube has a total length of between 40 mm and 55 mm, for example 42 mm to 52 mm. It is preferred that the hollow tube is substantially cylindrical.

A wall thickness of the hollow tube may be between 0.2 millimeter and 2 millimeter, preferably between 0.5 mm and 1.5 mm.

The method may further comprise pre-forming the cup-shaped susceptor from a piece of susceptor sheet material. Preferably, the cup-shaped susceptor is formed from a disc-shaped piece of susceptor sheet material. The disc may, for example, be cut-out from a sheet of aluminum foil or stainless steel foil.

The cup-shaped susceptor may have side walls that are even. The side walls of the cup-shaped susceptor may be corrugated. Preferably, corrugations are aligned in a longitudinal direction of the cup-shaped susceptor. The corrugations may be fluted or have a zig-zag pattern when seen along a cross section of the side wall, such as to form a cupcake-shaped susceptor.

Preferably, the side walls of the cup-shaped susceptor exert a retaining force onto the hollow tube when the cup-shaped susceptor is inserted and positioned in the hollow tube.

The side walls of a cup-shaped susceptor extend radially outward before being pushed radially inward to achieve a substantially cylindrical form, preferably corresponding to the internal diameter of the hollow tube. The corrugations allow a well-defined folding of the side walls of the susceptor when the susceptor is inserted in the hollow tube. In addition, the side walls may exert a retaining force between the susceptor and the hollow tube. This retaining force may support a positioning of the cup-shaped susceptor in the hollow tube and may prevent a cup-shaped susceptor from being displaced in the hollow tube once the cup-shaped susceptor has been positioned in the hollow tube.

To generate a retaining force, the diameter of the cup-shaped susceptor is larger than the inner diameter of the hollow tube, before the susceptor is positioned in the hollow tube. Preferably, the diameter of the cup-shaped susceptor is larger than the inner diameter of the hollow tube by at least 10 percent. Preferably, the diameter of the cup-shaped susceptor is larger than the inner diameter of the hollow tube by at least 1 millimeter. Upon positioning the cup-shaped susceptor, the side walls are compressed radially inwardly.

The cup-shaped susceptor may have a larger diameter over an entire length of the susceptor. The cup-shaped susceptor may have a larger diameter over a part of the length of the susceptor. Preferably, the cup-shaped susceptor has a larger diameter in an opening portion of the cup-shaped susceptor.

Preferably, the side walls of the cup-shaped susceptor have a certain elasticity and flexibility. The elasticity and flexibility allows to press the susceptor side walls radially inwardly without damaging or breaking the susceptor material. The elasticity and flexibility also causes the side walls to push radially outward and generate a retaining force when positioned in the hollow tube.

The cup-shaped susceptor may comprise an opening having a same diameter or a larger diameter than the bottom of the cup-shaped susceptor. The cup-shaped susceptor may have an opening having a diameter smaller than the diameter of the bottom. The cup-shaped susceptor may comprise positive locking means, for example arranged at the opening portion of the cup-shaped susceptor. For example, the cup-shaped susceptor may comprise an inwardly directing rim arranged around the opening of the cup-shaped susceptor.

Manufacturing of inductively heatable susceptor casings provided with an inwardly directing rim to retain an aerosol-forming gel inside the casing may, for example, be realized by embossing or folding. However, the small dimensions of the susceptor casing and its use in disposable aerosol-generating articles are demanding aspects in the manufacture of such casings. It is therefore desirable to have a manufacturing process for such casings, which is inexpensive, which uses little material and which allows mass production.

There is provided a method for forming a top-rim bended rod-shaped susceptor casing. The method may in particular be used for forming a rod-shaped susceptor casing to be filled with aerosol-forming gel to form an aerosol-generating rod segment according to the invention and as described herein.

The method comprises loading a forming tool with a disc of a susceptor sheet material such as an aluminium disc, deep drawing the disc to form a semi-finished casing, widen the side walls of the semi-finished casing, and inwardly bending a rim at the opening of the casing. Thereby, a rod-shaped susceptor casing is formed, which may be removed and further processed, such as being filled with an aerosol-forming gel and subsequently being introduced into an aerosol-generating article.

The deep drawing of the disc of susceptor sheet material is preferably performed by insertion of a plunger into a mold. Thereby the disc is deep drawn in the mold.

Preferably, the widening of the side walls of the semi-finished casing are performed by rotating the plunger along the sides of the mold, thereby pressing the side walls of the semi-finished casing against the walls of the mold.

The rim forming may generally be achieved by pressing the casing from below against an upper forming tool to bend the uppermost end portion of the side walls of the casing radially inwards.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating rod segment comprising a rod-shaped susceptor casing and an aerosol-forming gel contained in the rod-shaped susceptor casing, wherein the susceptor casing comprises a bottom, a side wall and an opening arranged opposite the bottom, and wherein the aerosol-forming gel is retained inside the susceptor casing in axial direction of the aerosol-generating rod segment by at least one positive locking means.

Example Ex2: The aerosol-generating rod segment according to example Ex1, wherein at least one of said at least one positive locking means is designed as an inwardly directed seam of the susceptor casing, in particular as an inwardly arranged flange.

Example Ex3: The aerosol-generating rod segment according to example Ex2, wherein the seam is arranged adjacent to an end section of the susceptor casing, which end section is arranged opposite the bottom of the susceptor casing.

Example Ex4: The aerosol-generating rod segment according to any one of example Ex2 to Ex3, wherein the seam is formed by an inwardly bent end portion of the side wall of the susceptor casing.

Example Ex5: The aerosol-generating rod segment according to any one of the preceding examples, wherein at least one of said at least one positive locking means is designed as a radially inwardly directing protrusion.

Example Ex6: The aerosol-generating rod segment according to example Ex5, wherein the radially inwardly directing protrusion has a radial extension in circumferential direction of the susceptor casing, which radial extension is larger than a longitudinal extension of the protrusion in longitudinal direction of the susceptor casing.

Example Ex7: The aerosol-generating rod segment according to example Ex5 or Ex6, wherein the radially inwardly directing protrusion is a radially inwardly directing deformation of the side wall of the susceptor casing.

Example Ex8: The aerosol-generating rod segment according to any one of examples Ex5 to Ex7, wherein the radially inwardly directing protrusion is arranged in an intermediate section of the side wall of the susceptor casing.

Example Ex9: The aerosol-generating rod segment according to any one of the preceding examples, wherein the at least one positive locking means is provided in one, two, three, four or a plurality of sectors of the susceptor casing, preferably in a circumferential range of each sector of at least 5 degree, 10 degree, 15 degree, 20 degree , 30 degree , 40 degree , 45 degree or up to 20 degree, 30 degree, 40 degree, 45 degree, 50 degree, 60 degree, 70 degree, 80 degree, 90 degree or 180 degree.

Example Ex10: The aerosol-generating rod segment according to any one of the preceding examples, wherein the aerosol-forming gel is retained in the cartridge by the at least one positive locking means with clearance in the longitudinal direction of the susceptor casing.

Example Ex11: The aerosol-generating rod segment according to any one of examples Ex1 to Ex9, wherein the aerosol-forming gel is fixed in its position in the susceptor casing by the at least one positive locking means.

Example Ex12: The aerosol-generating rod segment according to any one of the preceding examples, wherein at least one of the at least one positive locking means is arranged along an entire circumference of the susceptor casing, in particular along an entire circumference of the side wall of the susceptor casing.

Example Ex13: The aerosol-generating rod segment according to any one of the preceding examples, wherein at least part of the side wall of the susceptor casing is made of a susceptor material.

Example Ex14: The aerosol-generating rod segment according to any one of the preceding examples, wherein at least part of the bottom of the susceptor casing is made of a susceptor material.

Example Ex15: The aerosol-generating rod segment according to any one of the preceding examples, wherein the bottom of the susceptor casing is closed.

Example Ex16: The aerosol-generating rod segment according to any one of the preceding examples, wherein the side wall of the susceptor casing is even.

Example Ex17: The aerosol-generating rod segment according to any one of the preceding examples, wherein the side wall of the susceptor casing is corrugated.

Example Ex18: The aerosol-generating rod segment according to example Ex17, wherein corrugations are aligned in a longitudinal direction of the susceptor casing.

Example Ex19: The aerosol-generating rod segment according to any one of the preceding examples, wherein the side wall of the susceptor casing has the form of a cylinder.

Example Ex20: The aerosol-generating rod segment according to any one of the preceding examples, wherein the bottom and the side wall of the susceptor casing comprise a same thickness or a same material, or wherein the bottom and the side wall of the susceptor casing comprise a same thickness and a same material.

Example Ex21: The aerosol-generating rod segment according to any one of the preceding examples, wherein the bottom of the susceptor casing and the side wall of the susceptor casing are made as a single piece.

Example Ex22: The aerosol-generating rod segment according to any one of the preceding examples, wherein the bottom and the side wall of the susceptor casing comprise a different thickness or a different material, or wherein the bottom and the side wall of the susceptor casing comprise a different thickness and a different material.

Example Ex23: The aerosol-generating rod segment according to any one of the preceding examples, wherein the susceptor casing comprises or is made of aluminium or stainless steel.

Example Ex24: The aerosol-generating rod segment according to any one of the preceding examples, wherein the susceptor casing is formed from a sheet of susceptor material having a thickness between 5 micrometer and 80 micrometer, preferably between 8 micrometer and 50 micrometer.

Example Ex25: The aerosol-generating rod segment according to any one of the preceding examples, wherein the aerosol-forming gel is a gel plug.

Example Ex26: The aerosol-generating rod segment according to any one of the preceding examples, wherein the aerosol-forming gel has a filling height of at least 30 percent, 40 percent, 50 percent, 60 percent, 70 percent, 80 percent or at most 30 percent, 40 percent, 50 percent, 60 percent, 70 percent, 80 percent, 90 percent, 95 percent, 96 percent, 97 percent, 98 percent, 99 percent of the susceptor casing.

Example Ex27: The aerosol-generating rod segment according to any one of the preceding examples, wherein the aerosol-forming gel is entirely contained inside the susceptor casing.

Example Ex28: The aerosol-generating rod segment according to any one of the preceding examples, wherein the aerosol-forming gel comprises a solidifiable material.

Example Ex29: The aerosol-generating rod segment according to example Ex28, wherein the aerosol-forming gel comprises a thermoreversible material.

Example Ex30: The aerosol-generating rod segment according to any one of the preceding examples, wherein the aerosol-forming gel comprises between 0.5 percent and 5 percent by weight of a gelling agent.

Example Ex31: An aerosol-generating article comprising a plurality of segments arranged in an end-to-end position and wrapped in a wrapper to form a rod, the plurality of segments comprising an aerosol-generating rod segment according to any one of the preceding examples.

Example Ex32: The aerosol-generating article according to example Ex31, wherein the plurality of segments further comprise at least one of a hollow tube, a filter segment, an airflow directing element and an empty cavity.

Example Ex33: The aerosol-generating article according to any one of example Ex31 to Ex32, wherein the aerosol-generating rod segment is arranged between a hollow acetate tube and a filter segment.

Example Ex34: A method of manufacturing an aerosol-generating rod segment comprising:
providing a rod-shaped susceptor casing comprising a bottom, a side wall and an opening opposite the bottom;
filling aerosol-forming gel into the susceptor casing;
providing at least one form locking means in the aerosol-generating rod segment, the at least one form locking means retaining the aerosol-forming gel inside the susceptor casing.

Example Ex35: The method according to example Ex34, therein providing the at least one form locking means in the aerosol-generating rod segment after filling the susceptor casing with the aerosol-forming gel.

Example Ex36: The method according to any one of examples Ex34 or Ex35, forming at least one form locking means by radially inwardly bending at least parts of the side wall of the susceptor casing.

Example Ex37: The method according to example Ex36, inwardly bending an end portion of the side wall thereby defining a size of the opening of the susceptor casing.

Example Ex38: The method according to any one of examples Ex34 to Ex37, providing corrugations in the side wall of the susceptor casing.

Example Ex39: The method according to example Ex38, wherein the corrugations extend from the bottom to the opening of the susceptor casing.

Example Ex40: The method according to any one of examples Ex34 to Ex39, forming at least one form locking means by forming radially inwardly directing protrusions in the side wall of the susceptor casing.

Example Ex41: The method according to any one of examples Ex34 to Ex40, wherein the aerosol-forming gel is solidified after filling the aerosol-forming gel into the susceptor casing.

Example Ex42: The method according to any one of examples Ex34 or Ex41, wherein the aerosol-generating rod segment is an aerosol-generating rod segment according to any of examples Ex1 to Ex33.

Examples will now be further described with reference to the figures in which:

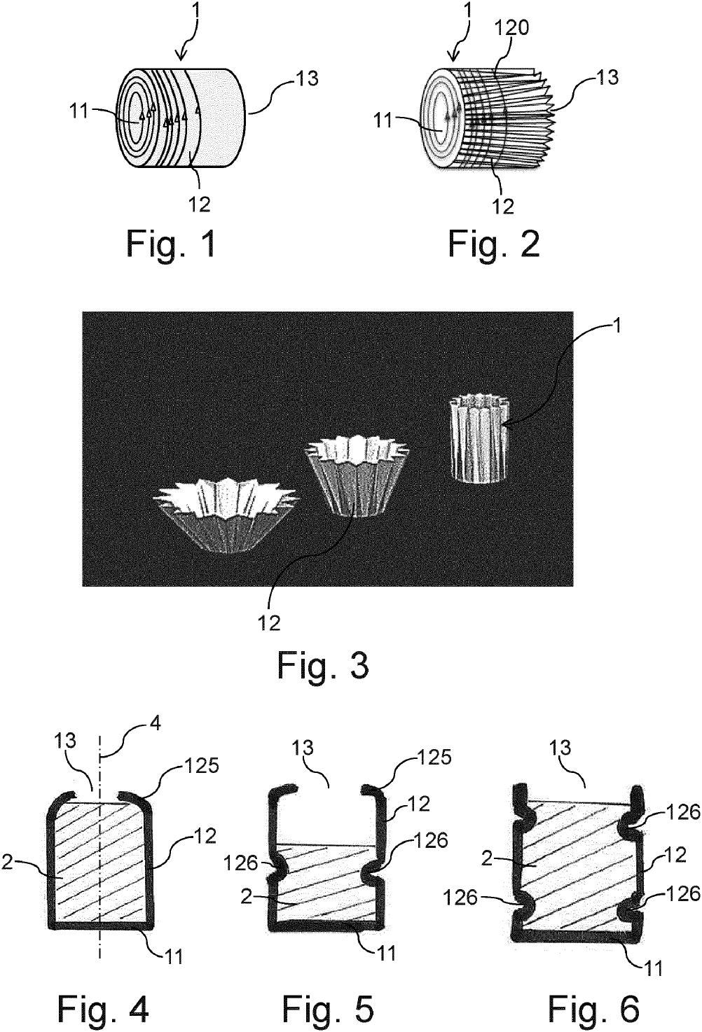

FIG. 1 shows a cup-shaped susceptor casing;

FIG. 2 shows a cup-shaped susceptor casing with corrugated side wall;

FIG. 3 shows a manufacturing series using a cup-cake shaped preformed casing;

FIGS. 4 to 6 schematically show longitudinal cross sections through a susceptor casing;

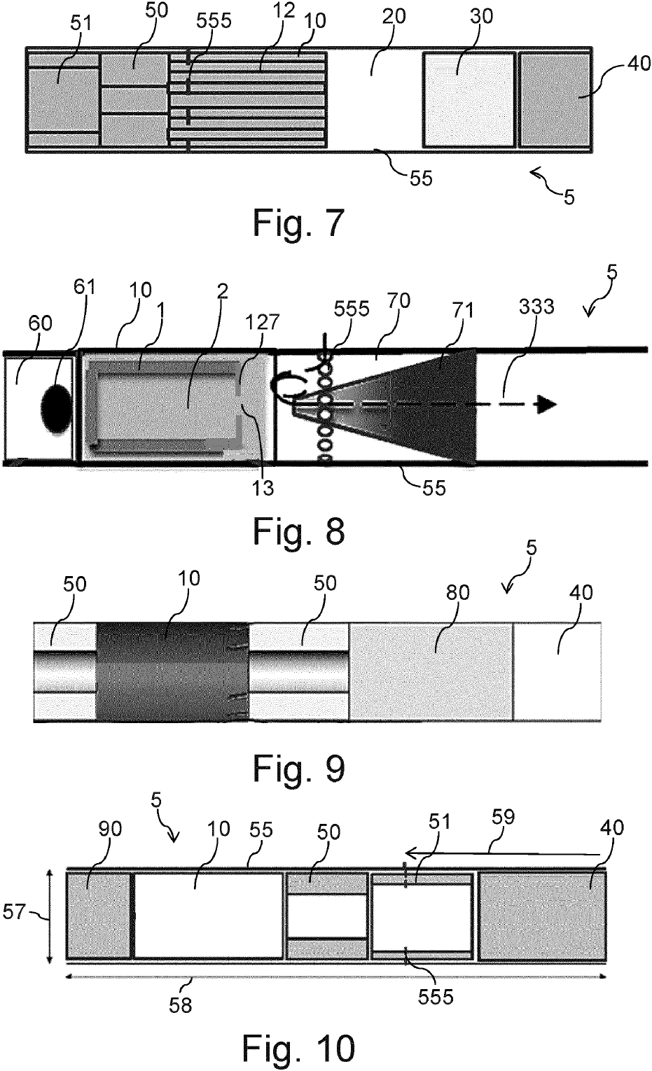

FIG. 7 shows an embodiment of an aerosol-generating article comprising an aerosol-generating rod segment;

FIG. 8 shows another embodiment of an aerosol-generating article comprising an aerosol-generating rod segment;

FIG. 9 shows yet another embodiment of an aerosol-generating article comprising an aerosol-generating rod segment;

FIG. 10 shows a further embodiment of an aerosol-generating article comprising an aerosol-generating rod segment;

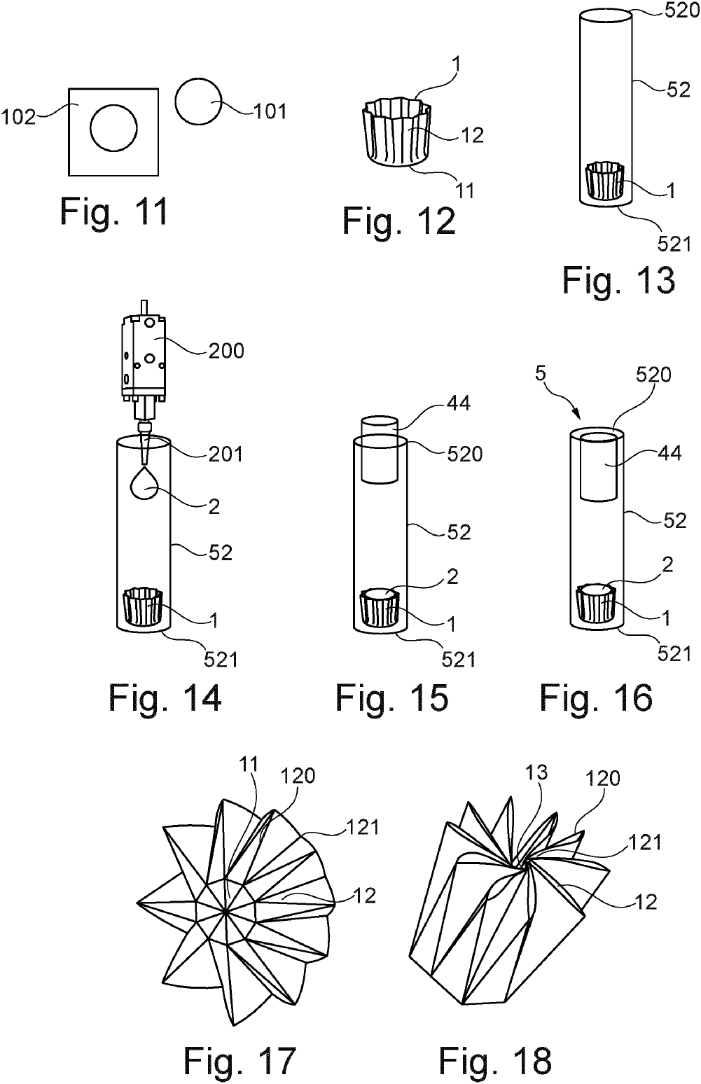

FIG. 11 to FIG. 16 shows a manufacturing process of an aerosol-generating article comprising a cup-shaped susceptor;

FIGS. 17 and 18 show an embodiment of a folded susceptor casing having a polygon-shaped bottom;

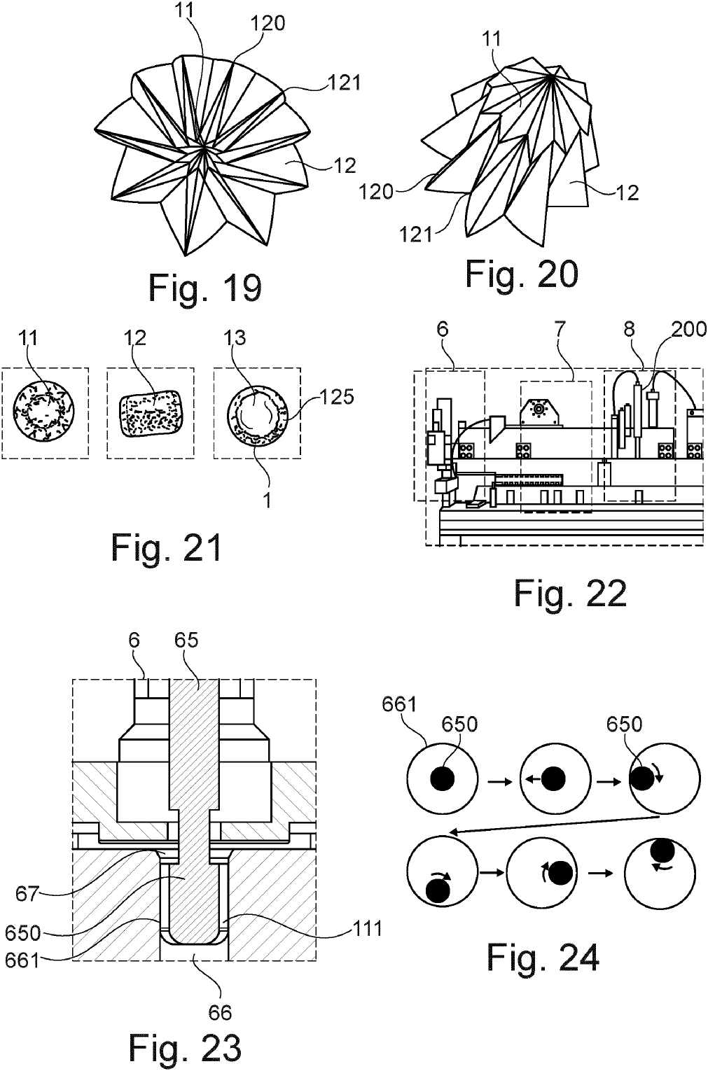

FIGS. 19 and 20 show further embodiments of folded susceptor casings having a polygon-shaped bottom with a bottom folded inside (FIG. 19) and a bottom folded outside (FIG. 20);

FIG. 21 shows a bottom view, side view and top view of an aluminium casing with inwardly bent rim;

FIG. 22 shows part of a set-up of an aerosol-generating article manufacturing process; and

FIGS. 23 to 25 illustrate a process of forming a cup-shaped aluminium casing.

In FIGS. 1 and 2 embodiments of susceptor casings are shown that are not yet provided with positive locking means.

In FIG. 1 a perspective side view of a cup-shaped casing 1 is shown. The casing has a bottom 11 and a side wall 12 extending from the bottom 11. The casing 1 has an opening 13 arranged opposite the bottom 11. The casing has the form of an open cylinder with a circular cross section, which cross section is substantially constant over the entire length of the casing. The casing 1 is partly or preferably entirely made of a susceptor material, for example stainless steel. The casing 1 is filled partly or entirely with an aerosol-forming gel (not shown).

An exemplary eddy current flow in the susceptor casing 1 induced by an inductor, in particular an induction coil arranged around the casing, is indicated with arrows.

In FIG. 2 a perspective side view of a cup-shaped casing 1 with a corrugated side wall 12 is shown. The corrugations 120 extend from the bottom 11 to the opposite end of the casing 1. The corrugations 120 get continuously more expressed from the bottom 11 into the direction of the opposite opening end. An exemplary eddy current flow in the susceptor casing 1 induced by an inductor, in particular an induction coil arranged around the casing, is indicated with arrows.

Positive locking means are not shown in FIGS. 1 and 2.

Exemplary data for casings as shown in FIGS. 1 and 2 are: 12 mg to 75 mg susceptor material; 160 mg aerosol-forming gel; intended temperature for the aerosol-forming gel: about 190 degree Celsius to about 200 degree Celsius. Aerosol-generating rod segments with the mentioned parameters may achieve a vaping experience of a duration of about 360 seconds.

In FIG. 3 an example of a step by step manufacturing of a casing as shown in FIG. 2 is illustrated. A susceptor sheet material may be preformed into a cup-cake shape as shown in the left drawing of FIG. 3. The radially outwardly directing side wall 12 of the cup-cake shaped casing is pressed radially inwardly until the casing 1 has a substantially same diameter over the entire length of the casing 1.

The positive locking means for retaining the gel in the casing may subsequently be provided in the casing 1, for example in one of more further manufacturing steps. Preferably, one or more positive locking means are provided in the casing in one further manufacturing step.

In FIGS. 4 to 6 examples of positive locking means are shown. In FIG. 4 the ends of the side wall 12 of the susceptor casing 1 opposite the bottom 11 of the casing direct inwardly. Preferably, this is achieved by bending the end portion 125 of the side wall 12 of the casing radially inwardly. The end portion 125 then forms a rim diminishing the opening 13 of the casing. The plug of aerosol-forming gel 2 inside the casing 1 may not fall out or be forced out of the opening 13 of the casing 1 as a diameter of the gel plug is larger than the diameter of the opening 13. The inwardly bent end portion 125 of the side wall 12 forms a positive lock for the gel 2 and has a retaining action for the gel in axial direction 4 of the casing 1. In FIG. 4 the susceptor casing 1 is entirely filled with aerosol-forming gel.

In FIG. 5 next to the inwardly bent end portion 125 of the side wall 12, the casing comprises radially inwardly directing protrusions 126. The protrusions 126 are formed by deformation of the side wall 12. The protrusions 126 are arranged in an intermediate section 128 of the casing 1, in about 40 percent to 60 percent of the length or height of the casing. In FIG. 5 the protrusion is arranged at about 40 percent of the length of the casing 1. Preferably, the protrusion 126 forms a rib that extends partially or entirely around the circumference of the casing. In FIG. 5 about half of the susceptor casing 1 is filled with aerosol-forming gel to about half the height of the casing 1. The protrusion 126 forms a positive lock for the gel 2 without clearance. The inwardly bent end portions 125 form a positive lock with clearance due to the distance between the filling height of the aerosol-forming gel and the inwardly bent end portions 125.

In FIG. 6 positive locking means are formed in the susceptor casing 1 by radially inwardly directing protrusions 126 arranged at different length positions of the casing 1. A first protrusion 126 is arranged at about 20 percent of the length of the casing 1, while a second protrusion 126 is arranged at about 80 percent of the length of the casing 1 counting from the bottom 11 of the casing 1. The protrusions 126 are formed by deformation of the side wall 12 and form ribs that extend partially or entirely around the circumference of the casing 1. The opening 13 of the casing 1 shown in FIG. 6 has as same diameter as the bottom 11 of the casing 1.

In the shown examples of FIGS. 4 to 6, protrusions 126 are arranged opposite each other in the casing 1. However, protrusions may also be arranged, for example, in a staggered manner over the height of the casing 1. Several protrusions, for example 3 to 10 protrusions, may be arranged in the casing 1. The sum of protrusions and further positive locking means retain the gel 2 in the casing 1 in axial direction.

FIG. 7 schematically shows an aerosol-forming article 5 comprising an aerosol-generating rod element 10 according to the invention. The aerosol-generating rod element 10 is a rod element having a corrugated side wall 12. The positive locking means are not shown in FIG. 7.

The aerosol-forming article 5 is rod-shaped and comprises six segments that are arranged in an end-to-end position. The aerosol-forming article 5 has a mouth end comprising a filter segment 40 at its most proximal end or most downstream end. An aerosol-cooling segment 30 is arranged adjacent to and upstream of the filter segment 40. An empty cavity 20 is arranged between the aerosol-cooling element 30 and the aerosol-forming rod segment 10. At the distal end of the aerosol-generating article 5 two hollow acetate tube segments (HAT) 50, 51 are arranged. The hollow acetate tube 51 arranged at the most distal end of the article 5 is a thin hollow acetate tube 51 and has a wall thickness smaller than the wall thickness of the hollow acetate tube 50 arranged adjacent the aerosol-generating rod segment 10. The hollow acetate tube 50 has a wall thickness of about 2 mm. The thin hollow acetate tube 51 has a wall thickness of about 0.8 mm.

The plurality of segments is wrapped in a wrapper 55, for example a paper or plastics wrapper. The individual segments may be individually wrapped before being assembled and wrapped with the wrapper 55 to form the rod-shaped aerosol-generating article 5.

The wrapper 55 comprises a row of perforations 555 for an airflow to pass and enter the wrapper 55 through the perforations 55. The perforations are arranged at an upstream end of the aerosol-generating rod segment 10. The airflow having entered the wrapper 55 passes outside and along the susceptor casing into the direction of the proximal end of the article 5. The airflow picks up vaporized substances from the heated aerosol-forming gel and forms an aerosol in the cavity 20, is cooled down in the aerosol-cooling element 30 and filtered in the filter element 40.

Exemplary values for the length of the individual segments of the article of FIG. 7 are: length for the thin HAT segment 51: 6 mm, length of the HAT 50: 5 mm, length of the aerosol-generating rod segment 10: 15 mm, length of the cavity 20: 8 mm, length of the aerosol-cooling element 30: 7 mm, length of the mouthpiece filter element 40: 4 mm. Total length of the article 5: 45 mm.

In FIG. 8 an embodiment of an aerosol-generating article 5 is schematically shown. The article comprises a plurality of segments wrapped in a wrapper 55. The aerosol-generating rod segment 10 is arranged between a most distally arranged front segment 60 and an airflow directing element 70.

The aerosol-generating rod segment 10 comprises a cup-shaped susceptor casing 1. The cup-shaped susceptor casing 1 has a constant circular cross section and comprises an inwardly directing flange 127, diminishing the size of the opening 13 of the casing 1. The material of the casing 1 is, for example, aluminium or stainless steel, for example Sxx or S4xx, such as SS430.

The aerosol-forming gel 2 is arranged inside the casing 1 as well as outside the casing 1. In the embodiment shown in FIG. 8 the aerosol-generating rod segment 10 is a gel plug comprising the susceptor casing, which gel plug defines the size of the aerosol-generating rod segment 10.

The front segment 60 comprises a ferrite bead 61. The ferrite bead 61 may, for example, be ferrite K1 and may have a size of about 2.4 mm and a weight between 10 mg to 20 mg.

The ferrite bead 61 is arranged at a proximal end of the front segment 60. By this, the ferrite bead 61 is arranged adjacent the aerosol-generating rod segment 10 and close to the bottom 11 of the casing 1 in the aerosol-generating rod segment 10. By this, a heating of the casing 1 may be enhanced in a bottom region of the casing 1 opposite the opening 13 of the casing.

The airflow-directing element 70 comprises a truncated hollow cone 71. The truncated end of the hollow cone 71 is directing versus the aerosol-generating rod segment 10. Vaporized gel enters the cone through the truncated end and expands in the cone 71 to be distributed over the entire cross section of the article.

The wrapper 55 wrapping the article 5 and keeping the individual segments in place comprises perforations 555 at a length position of the article corresponding to a distal region of the airflow-directing element 70. Air may enter the article 5 through the perforations 555 and gets into the airflow-directing element 70. The air is first led in an upstream direction as the cone entry is arranged at a position more upstream in the article 5 than the perforations 555. The air picks up vaporized gel and passes the cone in a downward direction. The aerosol comprising airflow 333 is then led further downstream to the mouth end of the article 5 (not shown).

In some embodiments the thickness of the susceptor material of the casing is 8.5 micron. In further embodiments the thickness of the susceptor material of the casing is 12 micron.

A casing 1 may, for example, have a weight of about 38 mg when empty and a weight of about 225 mg when filled with 187 mg gel.

In FIG. 9 the aerosol-generating article 5 comprises five segments. The aerosol-generating rod segment 10 is sandwiched between two hollow rod segments 50, for example two hollow acetate tubes. The one hollow tube is arranged at the most distal end of the article 5. Adjacent the more downstream arranged acetate tube 50 is an aerosol-cooling element 80 and a filter segment 40 at the most proximal end of the article 5.

The two hollow tubes 50 may be of a same construction. In FIG. 9, the hollow tube arranged at the most distal end of the article is shorter, for example by 2-5 mm shorter, than the more upstream arranged hollow tube. For example, the shorter hollow tube 50 may have a length of 4 mm. The longer hollow tube 50 may have a length of 8 mm. The hollow tubes have wall thicknesses of about 2 mm.

The article 5 shown in FIG. 10 comprises five segments: a front plug 90 followed by the aerosol-generating rod segment 10, followed by a hollow tube segment 50 and a thin hollow tube segment 51, followed by a filter segment 40 arranged at the most proximal end of the article 5.

The article has a diameter 57 of 7.23 mm and a total length 58 of 45 mm. The total length 58 is made up by the length of the individual segments: filter segment 40: 12 mm, hollow tubes each: 8 mm, aerosol-generating rod segment 10: 12 mm, front plug 90: 5 mm.

Perforations 555 in the wrapper 55 are arranged at a distance 59 of 18 mm from the most proximal end of the article 5. The perforations 555 and the airflow entering the article through the perforations 555 just upstream of the filter element 40 may cause a turbulent flow in the thin hollow tube 51. This may improve the filtering action of the aerosol containing airflow in the filter element 40.

In FIGS. 11 to 16 a manufacturing process of an aerosol-generating article 5 is shown in a simplified manner. In FIG. 11 a circular disc 101 of susceptor material has been cut-out from a susceptor sheet material, for example an aluminium foil or a stainless steel foil. The disc 101 is formed, preferably folded, into a cup-shaped susceptor 1 as shown in FIG. 12. The bottom 11 of the susceptor is circular and flat and the side walls 12 of the cup-shaped susceptor 1 are corrugated. The corrugations ar arranged along the length of the cup-shaped susceptor 1.

As may be seen in FIG. 13, the cup-shaped susceptor 1 is positioned within a hollow tube 52, for example a cardboard tube such as a spiral-wound cardboard tube. The hollow tube 52 is positioned in a vertical manner. The cup-shaped susceptor is inserted with its bottom 11 first in the hollow tube through the top end 520 of the hollow tube 52. The cup-shaped susceptor 1 is guided through the hollow tube 52 and positioned at the bottom end 521 of the hollow tube. The bottom 11 of the susceptor 1 may be flush with the bottom end 521 of the hollow tube 52.

The cup-shaped form of the susceptor 1 simplifies insertion of the cup-shaped susceptor as the bottom 11 preferably has a smaller diameter than the diameter of the side walls 12 at the opening of the cup-shaped susceptor.

Preferably, the cup-shaped susceptor 1 is slightly clamped in the hollow tube 52 by spring force of the side walls 12.

In FIG. 14, the dosing tip 201 of a dosing device 200 is inserted through the top end 520 into the hollow tube 52 for dosing a defined amount of aerosol-forming gel 2 into the cup-shaped susceptor 1. The gel 2, for example containing nicotine, may be supplied in a liquid or pasty form and may subsequently dry and harden in the cup-shaped susceptor. The liquid or pasty gel 2 flows into the corrugations of the side walls 11 and provides a close contact of the gel with the susceptor material.

In a final step as shown in FIGS. 15 and 16, an endpiece 44 is inserted into the hollow tube 52, also through the top end 520. The endpiece 44 typically comprises one or several filter segments. Preferably, the endpiece 44 is a preassembled composition of segments arranged in an end-to-end position. The endpiece 44 may comprise segments influencing aerosol-formation or having a filtering effect. For example, the endpiece 44 may comprise, a filter, a diffuser, an aerosol-cooling element or an aerosol-directing element.

The endpiece 44 is positioned at the top end 520 of the hollow tube 52. The endpiece 44 may be arranged flush with the top end of the hollow tube 52 or may be arranged in a slightly recessed manner forming an aerosol-generating article 5.

The cup-shaped susceptor 1 shown in FIGS. 12 to 16 may also be provided with positive locking means such as to retain the aerosol-forming gel in axial direction in the cup-shaped susceptor 1.

FIG. 17 and FIG. 18 show an enlarged example of an embodiment of a folded, cup-shaped susceptor casing 1 having a flat bottom 11 in the form of a polygon. The side walls 12 are corrugated in a way such that some folds 121 of the side wall 12 extend from the circumference of the bottom 11 of the cup-shaped susceptor 1 to the center of the opposite end of the cup-shaped susceptor, thus closing the opening 13 of the cup-shaped susceptor to a more or less degree depending on the extent that the side walls 12 are folded. Some other folds 120 of the side walls 12 extend from the circumference of the bottom 11 of the cup-shaped susceptor 1 basically in a straight manner to the opposite end of the cup-shaped susceptor, thus defining the outer diameter of the cup-shaped susceptor 1. Depending on the degree of folding the cup-shaped susceptor, the folds 120 of the side wall 12 direct radially outwards with respect to the bottom 11 to a more or less degree depending on the extent the side walls 12 are folded.

The folds 121 that continuously converge versus the opening of the cup-shaped susceptor 1 form positive locking means having a retaining action onto gel in the susceptor acting in the axial direction of the cup-shaped susceptor.

The side walls 12 of the cup-shaped susceptor 1 are also constructed to have a radial retaining force onto the cup-shaped susceptor itself, when the cup-shaped susceptor is used in an article as shown in FIG. 16.

FIG. 19 and FIG. 20 are further examples of folded cup-shaped susceptors 1 having a bottom 11 in the form of a polygon. In FIG. 19, the bottom 11 is folded and corrugated. The bottom 11 directs inwardly diminishing the volume of the cup-shaped susceptor and concentrating the susceptor material to a smaller area. In FIG. 20, the bottom 11 is folded and corrugated and directs outwardly enlarging the volume of the cup-shaped susceptor 1.

The folds of the side walls 12 may be folded in a similar manner as described in the example of FIGS. 17 and 18. The cup-shaped susceptors 1 may used as cup-shaped susceptor casings with positive locking means as well as cup-shaped susceptors having a retaining force on the casing itself to be fixed in its position when inserted and arranged in an aerosol-forming article as described in FIG. 16.

FIG. 21 shows a bottom view, a side view and a top view of an aluminium casing 1. The aluminium casing has a circular diameter with a small bottom 11, side walls 12 having a larger diameter than the diameter of the bottom 11 and an inwardly bent rim 125 at the opposite opening 13 side of the casing. The size of the opening 13 of the casing 1 is defined by the extent of the rim 125 being bent inwardly. The rim 125 has the function to retain a gel in longitudinal axial direction in the casing 1. The rim 125 also forms a surface for sealing a closing seal to the capsule 1. Casings may be filled with aerosol-forming gel and sealed such that the so formed aerosol-generating rod segment may be stored for later incorporation into an inductively heatable aerosol-generating article 5.

The casing 1 has been formed by deep drawing an aluminium disc, widening the side walls 12 of the casing and bending the rim 125. The thickness of the aluminium used for the casing may, for example, be 10 micrometer or may be 30 micrometer for embossed aluminium. Other materials suitable for being inductively heated, deep drawn and bent may be used for forming the casing.

In FIG. 22 three sequentially arranged stations 6,7,8 in an aerosol-generating article manufacturing process are shown. In the first station 6, a forming unit, the cup-shaped casing is formed. In the second station, an insertion unit, the cup-shaped casing is inserted into a coated cardboard tube, for example as described in FIG. 13 above. In the third station 8, the filling unit, an aerosol-forming gel is filled into the susceptor casing with a dosing device 200. The so manufactured semi-finished article may be further processed, for example as described with reference to FIGS. 15 and 16.

In FIG. 23 a first step of the casing forming in the forming unit 6 is shown. A cavity 661 in the lower part of the forming tool forms a mold.

The lower part of the forming tool comprises a vertically movable lower forming tool 66, its function will be described in more detail below. The top surface of the lower forming tool 66 forms the bottom of the mold.

A blank of sheet material, such as an aluminium disc, is loaded into the forming unit 6 above the cavity 661.

A plunger 65 is lowered, while the head 650 of the plunger is inserted into the cavity 661 from above. The plunger head 650 presses the aluminium disc into the cavity 661.

The diameter of the plunger 65 is smaller than the diameter of the cavity 661.

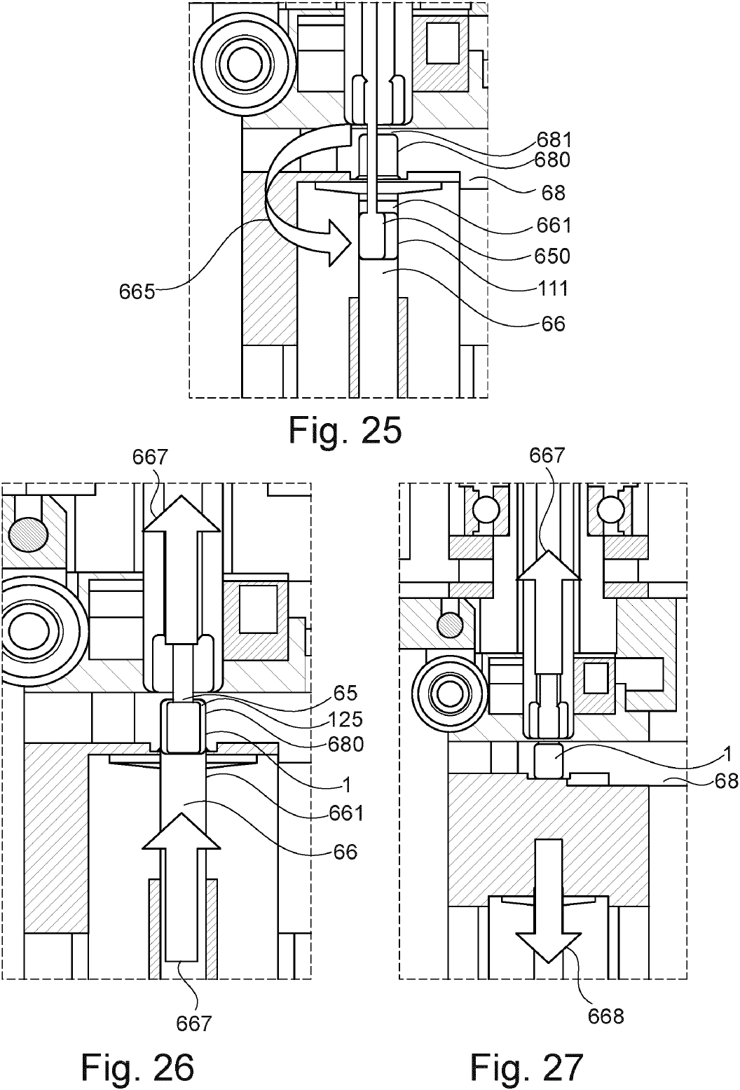

In order to widen the side walls of the semi-finishes casing 111, the plunger head 650 is moved along the side wall of the mold. The movement of the plunger 65 and the position of the plunger head 650 during the side wall extension of the casing is shown in FIG. 24 and FIG. 25.

FIG. 24 shows the movement path of the plunger head 650 in the cavity 661 for widening the side walls of the semi-finishes casing 111. The plunger 65 moves from the center of the cavity 661 to one side of the cavity. It then rotates along the sides of the mold defining the cavity. The plunger 65 simultaneously circles and rotates in the cavity 661. The position of the plunger 65 at a side of the cavity is shown in FIG. 25. The rotation of the plunger 65 is indicated by arrow 665.

For forming the rim and bending the upper portion of the side wall of the semi-finished casing 111, the plunger 65 and the lower forming tool 66 are lifted in the direction of arrows 667 as shown in FIG. 26.

The transfer plate 68 being part of the upper forming tool comprises a mold surface 680 with an inwardly directing edge mold 681.

Upon lifting the lower forming tool 66 and plunger 65 the semi-finished capsule 111 is guided through the cavity 661 while the plunger head 650 remains in the centre of the semi-finished casing 111. Upon pressing the semi-finished casing 111 against the edge mold 681 of the transfer plate 68, the rim 125 of the casing 1 is formed.

A vacuum applied to the casing may ensure the correct placement of the casing during transfer.

In yet a further step as shown in FIG. 27, the upper forming tool is lifter further and the lower forming tool 66 is lowered as indicated by arrows 667, 668 for releasing the finished casing 1.

Through the transfer plate 68, the casing 1 is removed from the forming tool 6.

The transfer plate 68 may then transfer the cup-shaped casing 1 to the next station 7 for insertion into a cardboard tube.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ± 2 % of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. An aerosol-generating rod segment, comprising:
a rod-shaped susceptor casing; and
an aerosol-forming gel contained in the rod-shaped susceptor casing,
wherein the rod-shaped susceptor casing comprises a bottom, a side wall, and an opening arranged opposite the bottom,
wherein the aerosol-forming gel is retained inside the rod-shaped susceptor casing in axial direction of the aerosol-generating rod segment by at least one positive locking means,
wherein the side wall of the rod-shaped susceptor casing is corrugated,
wherein at least one of the at least one positive locking means is an inwardly directed seam of the rod-shaped susceptor casing arranged adjacent to an end section of the rod-shaped susceptor casing, the end section being arranged opposite the bottom of the rod-shaped susceptor casing, and
wherein the inwardly directed seam is formed by an inwardly bent end portion of the side wall of the rod-shaped susceptor casing.

17. The aerosol-generating rod segment according to claim 16, wherein the inwardly directed seam of the rod-shaped susceptor casing is an inwardly arranged flange.

18. The aerosol-generating rod segment according to claim 16, wherein at least one of the at least one positive locking means is a radially inwardly directing protrusion.

19. The aerosol-generating rod segment according to claim 18, wherein the radially inwardly directing protrusion is a radially inwardly directing deformation of the side wall of the rod-shaped susceptor casing.

20. The aerosol-generating rod segment according to claim 16, wherein the aerosol-forming gel is retained in the rod-shaped susceptor casing by the at least one positive locking means with clearance in a longitudinal direction of the rod-shaped susceptor casing.

21. The aerosol-generating rod segment according to claim 16, wherein at least one of the at least one positive locking means is arranged along an entire circumference of the rod-shaped susceptor casing.

22. The aerosol-generating rod segment according to claim 16, wherein at least one of the at least one positive locking means is arranged along an entire circumference of the side wall of the rod-shaped susceptor casing.

23. The aerosol-generating rod segment according to claim 16, wherein at least part of the side wall of the rod-shaped susceptor casing is made of a susceptor material.

24. The aerosol-generating rod segment according to claim 16, wherein corrugations of the corrugated side wall of the rod-shaped susceptor casing converge radially inwardly forming the at least one positive locking means.

25. The aerosol-generating rod segment according to claim 16, wherein corrugations of the corrugated side wall of the rod-shaped susceptor casing are aligned in a longitudinal direction of the rod-shaped susceptor casing.

26. The aerosol-generating rod segment according to claim 16, wherein the bottom of the rod-shaped susceptor casing and the side wall of the rod-shaped susceptor casing are made as a single piece.

27. An aerosol-generating article comprising a plurality of segments arranged in an end-to-end position and wrapped in a wrapper to form a rod, the plurality of segments comprising an aerosol-generating rod segment according to claim 16.

28. The aerosol-generating article according to claim 27, wherein the plurality of segments further comprise at least one of a hollow tube, a filter segment, an airflow directing element, and an empty cavity.

29. The aerosol-generating article according to claim 27, wherein the aerosol-generating rod segment is arranged between a hollow acetate tube and a filter segment.
